(19) United States
(12) Patent Application Publication
(10) Pub. No.: US 2022/0025937 A1
(43) Pub. Date: Jan. 27, 2022

(54) SLIDING SLEEVE

(71) Applicant: Schaeffler Technologies AG & Co. KG, Herzogenaurach (BE)

(72) Inventors: Katrin Heider, Fürth (DE); Knut Erdmann, Nürnberg (DE); Christoph Karl, Mitwitz (DE)

(73) Assignee: Schaeffler Technologies AG & Co. KG, Herzogenaurach (DE)

(21) Appl. No.: 17/413,975

(22) PCT Filed: Dec. 17, 2019
(86) PCT No.: PCT/DE2019/101100

§ 371 Date: Jun. 15, 2021

(30) Foreign Application Priority Data
Dec. 17, 2018 (DE) 10 2018 132 517.7

(51) Int. Cl. F16D 23/06

(52) U.S. Cl. CPC F16D 23/06; F16D 2023/0631; F16D 2250/0053; F16D 2250/0046; F16D 2023/0656

(57) ABSTRACT

A sliding sleeve (1) of a vehicle transmission synchronization, wherein the tooth flanks (10) of the toothing (2) of the sliding sleeve (1) are surface-treated for enhanced friction.

### CROSS-REFERENCE TO RELATED APPLICATIONS

This application is the U.S. National Phase of PCT Appln. No. PCT/DE2019/101100 filed Dec. 17. 2019, which claims priority to DE 10 2018 132 517.7 filed Dec. 17, 2018, the entire disclosures of which are incorporated by reference herein.

### TECHNICAL FIELD

The disclosure relates to a sliding sleeve of a motor vehicle transmission.

### BACKGROUND

Sliding sleeves are used in motor vehicle transmissions to connect idler gears in a rotationally fixed manner to the synchronizer body arranged on the main transmission shaft. For this purpose, the sliding sleeve has internal toothing which is permanently engaged with external toothing of the synchronizer body. During a shifting operation, the speeds of the gear wheel and the synchronizer body are adjusted to one another by means of a synchronizer ring or a plurality of synchronizer rings. During this synchronization process, the transmission components are frictionally engaged. Due to the load, sliding sleeves are case-hardened and tempered.

As soon as the speeds are adjusted (synchronism), the thus synchronized gear can be shifted. For this purpose, the sliding sleeve is axially shifted so that it also meshes with a further toothing fixed to the gear wheel and creates a form fit that ensures a high degree of efficiency.

In order to prevent getting stuck in a shifting in the first operating hours of a synchronization, DE 102 30 189 A1 suggests providing the tooth profile of a sliding sleeve with a slide layer. The slide layer can be based on metal phosphates, PTFE, graphite, carbon, plastic, molybdenum sulfide, chromium, nickel or silver.

EP 1 150 028 A1 shows how to replace case hardening or nitriding of a sliding sleeve with local hardening in order to reduce component wear.

The power density of synchronizations can be further increased by lightweight construction. However, this is accompanied by increased loads that impair the functional reliability and service life of the synchronization components. Not only do the loads play a role during coupling, the loads in the shifted state also have an increasing influence.

The methods known from the prior art share the common purpose of reducing undesired wear caused by shifting. By reducing friction, they aggravate the problem that vibrations are increasingly transmitted in the shifted state, which put stress on the components of the synchronization.

### SUMMARY

It is desirable to create a synchronization which allows a low mass of the synchronization components and does not have the disadvantages mentioned above.

Toothing of a sliding sleeve is surface-treated in such a way that it has a higher coefficient of friction with the synchronizer body provided for engagement or the counter-toothing belonging to a gear wheel or coupling piece than it would have without the surface treatment.

Increased loads, such as those caused by vibrations, can be eliminated, due to the unnecessary surface treatment as a result of the form fit.

Preferably, only the sliding sleeve is subjected to a surface treatment, and the toothing partners remain untreated, which reduces the manufacturing costs of the synchronization, since the sliding sleeve toothing is engaged with two toothings in the shifted state, so that only one surface treatment is required.

In one embodiment, one of the toothings is shot-blasted, nitrided or cured. Alternatively or additionally, the toothing is coated.

The toothing can alternatively or subsequently be microstructured. For example, the surface coverage of the meshing components can be increased by laser-generated surface modifications. A friction-increasing shear can help to reduce vibrations or rotational irregularities introduced into the transmission so that the shifting components are not stressed in stationary operation. This increases the service life and functional reliability. Alternatively, the power density can be increased by eliminating the vibrations in the group of teeth.

In one embodiment, the toothing of the sliding sleeve is treated differently in different areas. The teeth thus experience a different surface modification compared to the tooth tips in the area of their tooth flanks which are engaged with the synchronizer body or the gear wheel or the coupling piece. While the aim is to reduce friction in the area of the tooth tips, the coefficient of friction in the tooth flank area should be increased. For this purpose, for example, an after-treatment can be carried out by laser structuring in the tooth flank area.

Furthermore, the surface treatment can, as is the sole purpose in the prior art, secondarily reduce the friction between the shift fork and the contact surfaces of the sliding sleeve. This reduces friction losses. In some cases, a coating at this point can therefore be dispensed with.

### BRIEF DESCRIPTION OF THE DRAWINGS

In the figures:

FIG. 1 shows a partial view of a first sliding sleeve with internal toothing and

FIG. 2 shows a perspective view of a further sliding sleeve.

### DETAILED DESCRIPTION

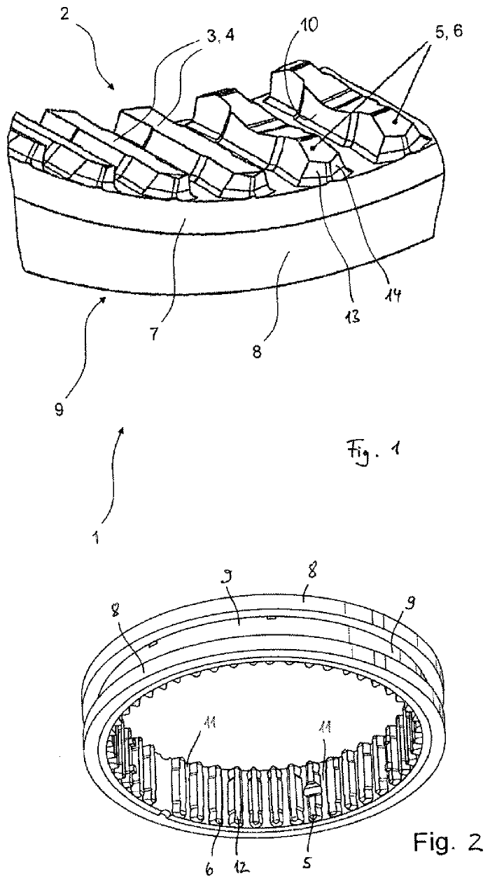

The schematic illustration of FIG. 1 shows a partial view of a sliding sleeve 1 with a toothing 2 designed as internal toothing. The toothing 2 is designed in a known manner as straight toothing. The individual teeth 3, 5 of the toothing each have a flattened cross-section 4 with inclined tooth flanks 10 tapering upwards. Some of the teeth 5 have a flattened cross-section on the end side as a roof pitch 6, which can serve in particular for improved presynchronization when the sliding sleeve 1 is axially displaced in the direction of a gear wheel with external toothing (not shown). In addition to the toothing 2, the annular sliding sleeve 1 comprises a closed toothing ring 7, which carries the toothing 2, and a groove-like engagement 9 for a shifting element (not shown), in particular for a shift fork, is attached to its outer jacket 8 in a rotationally fixed manner.

The toothing 2 has tooth flanks 10 which are oriented in the circumferential direction. On the end side, the tooth flanks 10 merge into the roof pitches 6, which in turn open into V-shaped end faces 13, 14. Together with the roof pitches 6, the end faces 13, 14 form roof tips. The entire sliding sleeve 1 of FIG. 2 is nitrided, wherein the tooth flanks 10 are surface-treated in such a way that their friction with the counter-toothing is greater than it would be in the untreated state. Their surface structure and thus their coefficient of friction also differs in the present case from that of the tooth roofs 12, the tooth bases 11 and that of the roof pitches 6 and end faces 13, 14 due to the duration and conditions of the nitriding process.

### LIST OF REFERENCE SYMBOLS

1 Sliding sleeve
2 Internal toothing
3 Tooth
4 Flattened cross-section
5 Tooth
6 Roof pitch
7 Toothing ring
8 Outer jacket
9 Engagement
10 Tooth flank
11 Tooth base
12 Tooth roof
13 End face
14 End face

1. A sliding sleeve for a vehicle transmission synchronization with a toothing, wherein the toothing of the sliding sleeve is surface-treated for enhanced friction.

2. The sliding sleeve according to claim 1, wherein the toothing is surface-treated on its tooth flanks which engage in a shifted state.

3. (canceled)

4. The sliding sleeve according to claim 1, wherein the toothing is nitrided.

5. The sliding sleeve according to claim 1, wherein the toothing is strength-blasted or cured.

6. The sliding sleeve according to claim 1, wherein the toothing is coated.

7. The sliding sleeve according to claim 1, wherein the toothing is microstructured.

8. The sliding sleeve according claim 1, wherein the toothing has tooth flanks facing in a circumferential direction and end-face roof tips, wherein a surface structure of the tooth flanks differs from a surface structure of the end-face roof tips.

9. A sliding sleeve for a vehicle transmission, the sliding sleeve having toothing, wherein the toothing has tooth flanks facing in a circumferential direction and end-face roof tips, wherein a surface structure of the tooth flanks differs from a tooth structure of the end-face roof tips.

10. The sliding sleeve according to claim 9, wherein the tooth flanks are surface-treated for enhanced friction.

11. The sliding sleeve according claim 10, wherein the toothing is nitrided.

12. The sliding sleeve according to claim 10, wherein the toothing is strength-blasted or cured.

13. The sliding sleeve according to claim 10, wherein the toothing is coated.

14. The sliding sleeve according to claim 10, wherein the toothing is microstructured.
